(19) United States
(12) Patent Application Publication
(10) Pub. No.: US 2025/0123779 A1
(43) Pub. Date: Apr. 17, 2025

(54) INFORMATION PROCESSING APPARATUS, MAINTENANCE SUPPORT SYSTEM, AND MAINTENANCE SUPPORT METHOD

(71) Applicant: CANON KABUSHIKI KAISHA, Tokyo (JP)

(72) Inventor: KEISUKE NIIMOTO, Kanagawa (JP)

(21) Appl. No.: 18/913,453

(22) Filed: Oct. 11, 2024

(30) Foreign Application Priority Data
Oct. 12, 2023 (JP) 2023-176878

(51) Int. Cl. G06F 3/12

(52) U.S. Cl. CPC G06F 3/121; G06F 3/1234; G06F 3/1288

(57) ABSTRACT

An information processing apparatus that displays a countermeasure method of an error or a maintenance item to a user is downloads, from a server, service manual information including countermeasure methods for each error or maintenance item for respective image forming apparatuses and a priority for each countermeasure method, and stores the downloaded service manual information. Countermeasure methods corresponding to an error or maintenance item that occurred on an image forming apparatus and a priority for each countermeasure method are acquired from the stored service manual information, and the countermeasure methods and priorities are displayed.

### BACKGROUND

### Field

The present disclosure relates to an information processing apparatus, a maintenance support system, and a maintenance support method for supporting maintenance of an image forming apparatus.

### Description of the Related Art

In the commercial printing field, downtime of an image forming apparatus is directly linked to losses, and therefore, there is a need for a high operating rate for image forming apparatuses. Therefore, when maintenance is performed on an image forming apparatus or when an error occurs, an operator can handle situations where the required maintenance work is light. When the situation is such that the operator cannot handle the maintenance work, a maintenance worker is dispatched to the location of the image forming apparatus. The maintenance worker typically needs to quickly deal with the issues to reduce losses due to downtime.

Maintenance support systems exist which, in order to attempt to improve the efficiency of a maintenance worker's work, display errors and maintenance items in a worklist in order of priority to thereby support the maintenance work. The maintenance worker refers to the worklist and implements countermeasures in order of priority, thereby reducing unnecessary work. This enables confirming a service manual describing a work procedure for an item selected from the worklist, which supports efficient maintenance work.

An issue with such maintenance support systems that generate a worklist based on phenomena occurring in an image forming apparatus and that indicate countermeasure methods is that there are cases where it is not possible to narrow down to one countermeasure method based on the phenomena. Since there is more than one candidate for the cause of an error that has occurred, there can be a plurality of countermeasure methods. In this case, the selection of the countermeasure method from the plurality of countermeasure methods depends on the maintenance worker, where a less experienced and skilled maintenance worker may not necessarily be able to make the correct selection.

Japanese Patent Laid-Open No. 2020-199704 proposes an image forming apparatus communicating with a failure diagnosis server at a location where the maintenance is to be performed, where a worker receives support from the failure diagnosis server. The failure diagnosis server estimates a cause of failure from various device information, such as an error received from the image forming apparatus, thereby narrowing down a plurality of cause candidates, and presents the results to the maintenance worker by displaying the results on the image forming apparatus. This approach presumes that the image forming apparatus and the failure diagnosis server communicate with each other. In situations where an environment the maintenance worker needs to work in may restrict external communication, the diagnosis server of Japanese Patent Laid-Open No. 2020-199704 may not be applicable.

One error countermeasure method is to replace a part that is a cause of the error. However, in addition to replacing the part causing the error, cleaning or adjusting the part may also be a solution to fixing the error. Replacing a part where cleaning or adjusting the part is an option, can result in the loss of the remaining value in the undamaged part, which can lead to increased maintenance costs. Thus, selecting an appropriate countermeasure method is important. However, even if a part causing an error is identified, selecting an appropriate countermeasure method and the procedure to implement the method may not be easy for less experienced or skilled maintenance workers.

### SUMMARY

The present disclosure has been made in view of the above issues, and an aspect of the present disclosure is to provide an information processing apparatus and a maintenance support system that can support a maintenance worker without depending on the environment the maintenance work is currently located in.

According to an aspect of the present disclosure an information processing apparatus that displays countermeasure methods of errors or maintenance items to a user, the apparatus comprising at least one memory storing instructions, and at least one processor, that when executing the stored instructions causes the information processing to download, from a server, service manual information including countermeasure methods for each error or maintenance item associated with respective image forming apparatuses and a priority for each countermeasure method, store the downloaded service manual information, to acquire, countermeasure methods corresponding to an error or maintenance item that occurred on an image forming apparatus and a priority for each countermeasure method, and display the countermeasure methods and priorities,.

Further features of the present disclosure will become apparent from the following description of exemplary embodiments with reference to the attached drawings.

### BRIEF DESCRIPTION OF THE DRAWINGS

FIG. 1 is a block diagram illustrating the entire maintenance support system according to a first embodiment

FIG. 2 is a hardware configuration view of an information processing apparatus and a maintenance service terminal according to the first embodiment.

FIG. 3 is a functional block diagram of the maintenance service terminal and the information processing apparatus according to the first embodiment.

FIG. 4 is a functional block diagram of a service work record management system and a service manual management system according to the first embodiment.

FIG. 5 is a view illustrating an example of a service work record database according to the first embodiment.

FIG. 6 is a view illustrating an example of work record statistical information database according to the first embodiment.

FIG. 7 is a flowchart of a statistical processing unit according to the first embodiment.

FIG. 8 is a flowchart of a market record information generation unit according to the first embodiment.

FIG. 9 is a view illustrating an example of a service tool worklist screen according to the first embodiment.

FIG. 10 is a view illustrating an example of a service manual screen according to the first embodiment.

FIG. 11 is a flowchart of a market record information generation unit according to a second embodiment.

FIG. 12 is a view illustrating an example of a service manual screen according to the second embodiment.

FIG. 13 is a flowchart of a market record information generation unit according to a third embodiment.

FIG. 14 is a view illustrating an example of a service manual screen according to the third embodiment.

FIG. 15 is a diagram illustrating a configuration example of a service manual database.

FIG. 16 is a flowchart of the procedure for displaying the service manual.

### DESCRIPTION OF THE EMBODIMENTS

Hereinafter, embodiments will be described in detail with reference to the accompanying drawings. The following embodiments are not intended to limit the scope of the attached claims. Multiple features are described in the embodiments, but the disclosure is not limited to having all such features, and a plurality of the features can be combined as appropriate. Furthermore, in the attached drawings, the same reference numerals are given to equivalent or similar configurations, and redundant description thereof is omitted.

### First Embodiment

### Configuration of Maintenance Support System

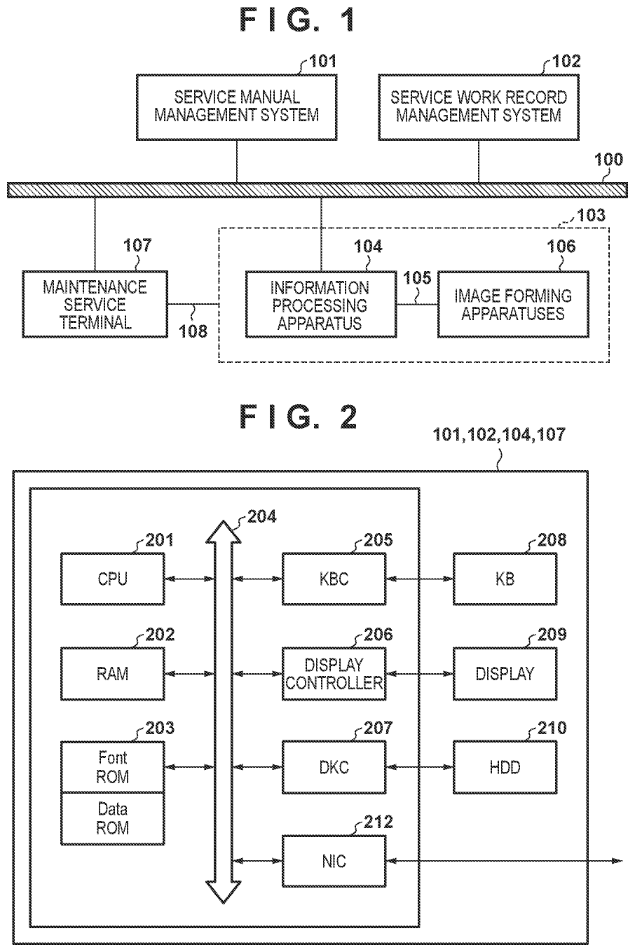

FIG. 1 is a block diagram illustrating a maintenance support system according to a first embodiment. The maintenance support system is includes a service manual management system 101, a service work record management system 102, a printing company system 103, and a maintenance service terminal 107, which are connected to each other via the Internet 100. The service manual management system 101 and the service work record management system 102 can be software systems executed by servers, for example, a service manual management server and a service work record management server, respectively. The printing company system 103 and the maintenance service terminal 107 are connected by a local connection 108, such as a local network or a USB connection. A connection 105 between an information processing apparatus 104 and an image forming apparatus 106 can be a local connection, such as a local network or a USB connection, or can be a connection via the Internet 100.

The image forming apparatus 106 is controlled by a program group operating on the information processing apparatus 104, and processes print data according to print settings to produce a printed product. The maintenance service terminal 107 communicates with the printing company system 103 to acquire device status and operational information of the image forming apparatus 106. A service tool installed in the maintenance service terminal 107 uses the device status and operational information to provide a maintenance support service to a maintenance worker. In order to display a service manual to a maintenance worker, the maintenance service terminal 107 can download the service manual from the service manual management system 101 to the maintenance service terminal 107. The service work record management system 102 stores a maintenance worker's work history statistical information, and is connected to the service manual management system 101 via the Internet 100. The maintenance service terminal 107 can acquire, from the service work record management system 102, statistical information for each error countermeasure method included in the service manual.

The service manual is service manual information stored in a database as described below, and each database record includes model information such as a model name, a work reason such as an error code, a countermeasure part that is a target of the work, and a countermeasure method for each countermeasure part. Countermeasure parts are associated with a countermeasure probability indicating a record as to how much a countermeasure was implemented for the respective part. In addition, procedure information such as text indicating a procedure of a countermeasure method and a rank indicating an order in which countermeasure methods have been selected by maintenance workers are associated with the countermeasure method. A database record is a logical record, and can be divided into a plurality of tables in a database. The service manual information can be referred to as just a “service manual” in the following description.

FIG. 2 is a block diagram illustrating a configuration of the information processing apparatus 104 and the maintenance service terminal 107 according to the present embodiment. Each server that implements the service manual management system 101 and the service work record management system 102 can have a similar configuration.

In FIG. 2, a CPU 201 executes a program of an OS or a general application stored in a program ROM of a ROM 203 or loaded from an HDD 210 into a RAM 202. The ROM 203 has a font ROM and a data ROM. The RAM 202 functions as a main memory, a work area, and the like of the CPU 201. A keyboard controller (KBC) 205 controls inputting from a keyboard (KB) 208 or a pointing device (not illustrated). A display controller 206 controls display on a display 209. A disk controller (DKC) 207 controls access to the HDD 210, which stores a boot program, various applications, font data, and the like. A network controller (NIC) 212 is connected to a network and executes a communication control process with other devices connected to the network. A bus 204 connects the CPU 201 and the RAM 202, the ROM 203, various controllers, and the like, and carries data signals and control signals.

When the maintenance service terminal 107 is a mobile telephone, a touch panel controller or the like can be included in the configuration instead of the keyboard controller (KBC) 205. A mass storage device can also be included to replace the HDD 210. The network controller (NIC) 212 has a different inner configuration in a case where the apparatus that comprises it is to be connected to a wired LAN or a wireless LAN or both. These internal configuration differences are hidden within the network controller (NIC) 212, and configuration is such that the system can be controlled that, to the other modules illustrated in FIG. 2, it is equivalent.

### Functional Blocks of Printing Company System and Maintenance Service Terminal

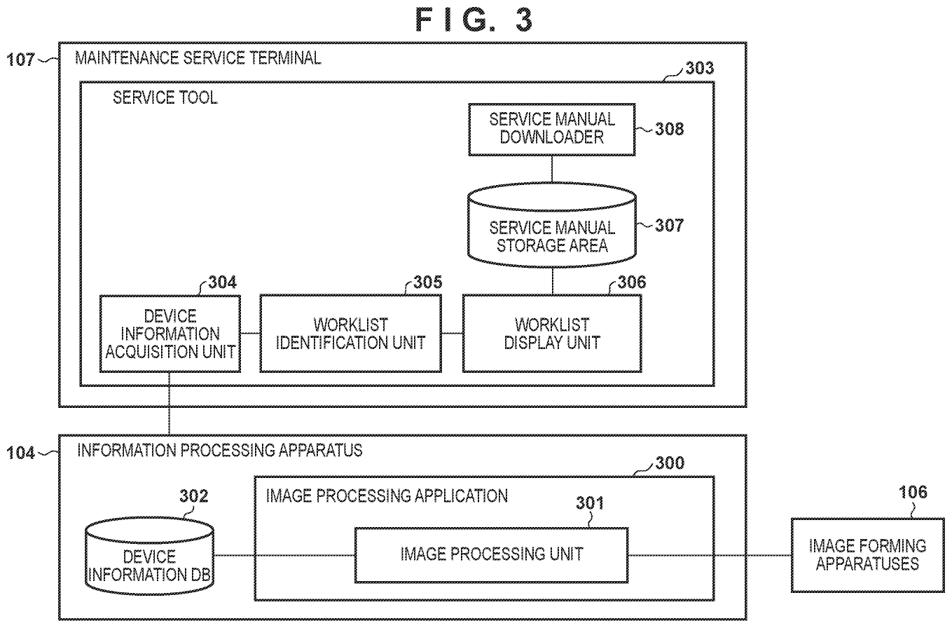

FIG. 3 is a functional block diagram of the printing company system 103 and the maintenance service terminal 107 constituting the maintenance support system according to the present embodiment. First, functional blocks installed in the information processing apparatus 104 of the printing company system 103 will be described.

An image processing application 300 is an application program for controlling the image forming apparatus 106. Communication with the image forming apparatus 106 is performed via the connection 105. Upon receiving a print execution instruction for a print job, the image processing application 300 converts print data into image data via an image processing unit 301, and transfers the image data to the image forming apparatus 106 together with a print execution command.

A device information database (DB) 302 stores device information and operation information of the image forming apparatus 106, such as a history of print jobs performed by the image forming apparatus 106 and an error history for errors that have occurred.

Next, functional blocks installed in the maintenance service terminal 107 will be described. An application program called a service tool 303 is installed in the maintenance service terminal 107. The service tool 303 provides the maintenance worker with functions and service manuals necessary for maintenance and inspection of the image forming apparatus 106 and recommended work for maintenance and inspection. In the present embodiment, the maintenance service terminal 107 includes the service tool 303, but the configuration of the information processing apparatus 104 can such that it is built into the image forming apparatus 106.

The service tool 303 includes a device information acquisition unit 304, a worklist identification unit 305, a worklist display unit 306, a service manual storage area 307, and a service manual downloader 308. The device information acquisition unit 304 communicates with the information processing apparatus 104 and acquires a history of device information and operation information stored in a device information DB 302. The worklist identification unit 305 identifies errors and maintenance items for which a countermeasure is to be taken based on the information acquired by the device information acquisition unit 304. The worklist display unit 306 displays, on the service tool 303, errors and maintenance items for which a countermeasure is to be taken and that have been identified by the worklist identification unit 305. The worklist display unit 306 also has a function of displaying a service manual corresponding to errors and maintenance items for which a countermeasure is to be taken. As the service manual to be displayed on the worklist display unit 306, a service manual (or a part thereof) downloaded to the service manual storage area 307 included in the maintenance service terminal 107 is used. The service manual downloader 308 acquires service manual data from the service manual management system 101 via the Internet 100 and stores the service manual data in the service manual storage area 307. It is not necessarily possible to use the Internet 100 in the environment where maintenance is to be performed.

It is not necessarily possible to use the Internet 100 in the location where maintenance is to be performed. Therefore, the maintenance worker connects the maintenance service terminal 107 to the Internet 100 in advance, uses the service manual downloader 308, downloads the service manual data, and then visits the location where maintenance is to be performed.

### Functional Blocks of Service Manual Management System and Service Work Record Management System

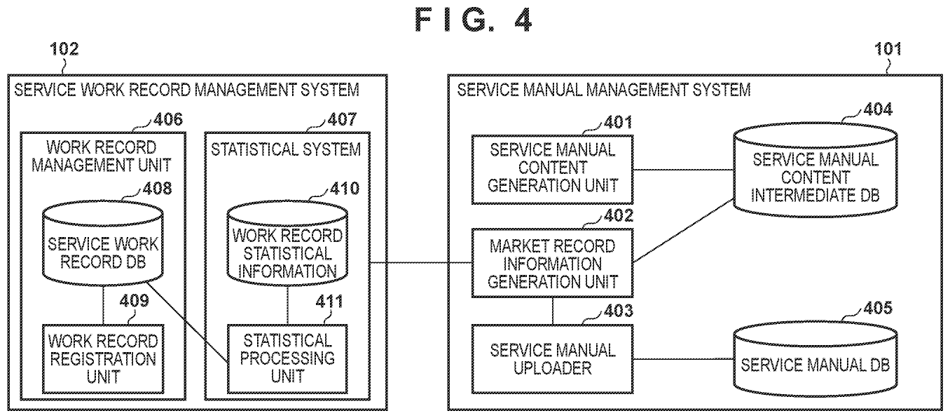

FIG. 4 is a functional block diagram of the service manual management system 101 and the service work record management system 102 which constitute the maintenance support system according to the present embodiment.

First, functional blocks installed in the service work record management system 102 will be described. The service work record management system 102 includes a work record management unit 406 and a statistical system 407. A work record registration unit 409 of the work record management unit 406 can register maintenance work performed by a maintenance worker and a result thereof in a service work record DB 408. As the registration method, in addition to a method by which the maintenance worker inputs the information using the maintenance service terminal 107, a method by which the information is automatically registered from the information processing apparatus 104 via the Internet 100 is also conceivable. The registered maintenance work information and results therefor are accumulated in the service work record DB 408.

A statistical processing unit 411 of the statistical system 407 acquires accumulated work records from the service work record DB 408. Then, based on the acquired work records, it calculates statistics on countermeasure methods performed for each model of image forming apparatus 106 for each error and maintenance and inspection item (maintenance item) occurring in the model. The statistics can include, for example, a ratio of each countermeasure method with respect to the total number of countermeasures performed for each item, a ratio of a target part (also referred to as a related part) to which a selected countermeasure method is applied with respect to the total number of countermeasures performed, and the like. The statistical results of work records calculated by the statistical processing unit 411 are recorded in work record statistical information 410.

Next, functional blocks installed in the service manual management system 101 will be described.

A service manual content generation unit 401 collects content data including related part information and countermeasure method information for each model of the image forming apparatus 106 for each error and maintenance and inspection item generated in the model, and generates intermediate data of the service manual. In addition to the original data of the service manual, the intermediate data of the service manual includes a list of errors and maintenance items that can occur for each model. In addition, content data may be created for new errors and maintenance and inspection items in response to user input. The intermediate data of the generated service manual is stored in a service manual content intermediate DB 404. A service manual uploader 403 communicates with a market record information generation unit 402 to acquire intermediate data of the service manual at the time of updating the service manual.

The market record information generation unit 402 acquires the target intermediate data from the service manual content intermediate DB 404. Then, market record data for countermeasures or maintenance and inspection items for an error of the intermediate data is acquired from the statistical system 407, and statistical results are added to the content of the intermediate data of the service manual. When the results are added, statistical information corresponding to a corresponding error or maintenance and inspection item is added in association with corresponding countermeasure methods.

The service manual uploader 403 performs data forming and format conversion on the intermediate data of the service manual including the statistical results updated by the market record information generation unit 402, and stores the results in a service manual DB 405. The previously described service manual downloader 308 acquires the service manual stored in the service manual DB 405.

### Database Examples

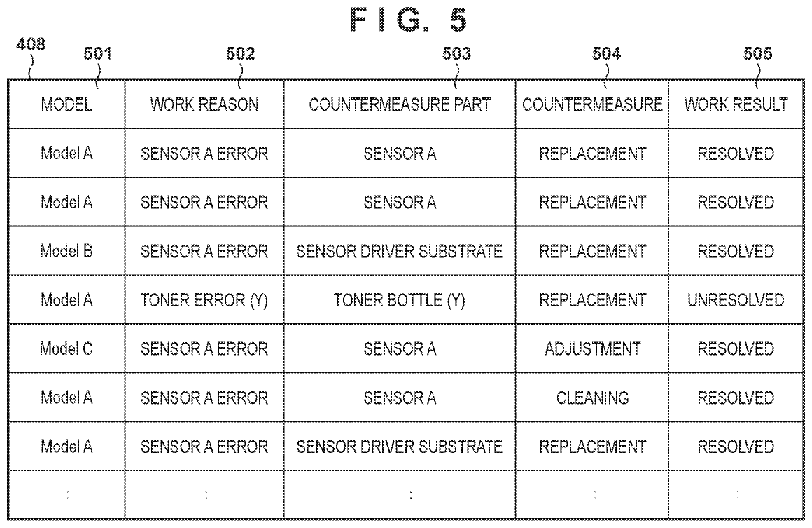

FIG. 5 illustrates an example of data stored in the service work record DB 408 of FIG. 4.

The service work record DB 408 includes five columns.

A model column 501 stores a name of a model for which the maintenance work was performed. A work reason column 502 stores an error or a maintenance item that is the reason for performing the maintenance work. A countermeasure part column 503 stores information on a part for which a countermeasure was taken, that is, a related part. In the present embodiment, a part name is stored, but a part ID indicating the part may be stored. A countermeasure column 504 stores a classification of the countermeasure method performed on the part of the countermeasure part column 503. In the present embodiment, a countermeasure method selected from any of three classifications (replacement/adjustment/cleaning) is stored. A work result column 505 stores a maintenance work result such as whether the error was resolved or was not resolved after the maintenance work, or whether the maintenance was completed or was not completed. Regarding this information, information for work performed on all models in the market is collected and stored. However, in regards to target regions, a configuration may be taken to divide the database for each country or each sales company, rather than a configuration in which the information is registered in a shared database for the entire world.

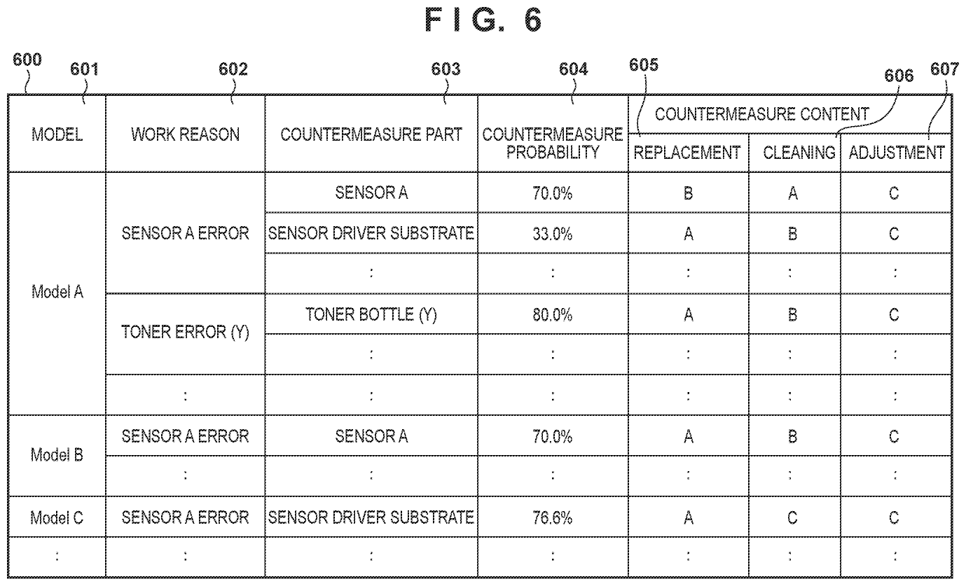

FIG. 6 illustrates an example of data stored in the work record statistical information 410 of the service work record management system 102 in FIG. 4. A work record statistical database 600 which constitutes the work record statistical information 410 includes seven columns, and the results of aggregation performed by the statistical processing unit 411 are stored in information stored in the service work record DB 408.

A model column 601 stores a name of a model for which maintenance work was performed, and corresponds to the model column 501 of the service work record DB 408. A work reason column 602 stores an error or a maintenance item that is a reason for performing the maintenance work, and corresponds to the work reason column 502 of the service work record DB 408. A countermeasure part column 603 stores information of a part for which the countermeasure was taken, and corresponds to the countermeasure part column 503 of the service work record DB 408. In the present embodiment, a part name is stored, but a part ID indicating the part may be stored. A countermeasure probability column 604 stores a proportion of records of countermeasures performed on the part of the countermeasure part column 603, which is calculated by the statistical processing unit 411. A countermeasure content replacement column 605 stores a rank of countermeasure records for which the countermeasure column 504 of the service work record DB 408 falls under “replacement”, which is calculated by the statistical processing unit 411. The rank is determined in accordance with the proportion of “replacement” to the total number of countermeasures taken for the target countermeasure part, and A is set for a proportion of 50% or more, B is set for 20% or more and less than 50%, and C is set for 20% or less.

The number of countermeasure methods may be calculated by the following method. For example, referring to the service work record DB 408, for the database records whose work result column 505 is “resolved”, the number of database records for which the model column 501, the work reason column 502, the countermeasure part column 503, and the countermeasure column 504 are the same is counted.

The counted number is the number of countermeasures corresponding to a corresponding part for which the countermeasure method has been taken against the corresponding error when it occurred in the corresponding model. The rank of the countermeasure record may be made to be in accordance with a value resulting from dividing this number by a parameter. The parameter may be the total count, that is, the number of database records in which the work result column 505 is “resolved”. This is a statistic for an error, but configuration may be similar for the case of maintenance, and in that case, database records for which the work result column 505 is “completed” may be targeted. However, the rank determination method of the present embodiment is merely an example, and the present invention is not limited to this; the value of the proportion percentage [%] may be stored instead of the rank. Similarly, in a cleaning column 606 and an adjustment column 607 of the countermeasure content, the countermeasure column 504 of a database 500 stores the ranks of countermeasure records falling under “cleaning” and “adjustment”, which are calculated by the statistical processing unit 411. In addition, since it is inefficient to re-count the number of database records every time the rank is updated, the count for each countermeasure method which is a basis for the rank and the total number which is the parameter may be stored, the proportion may be updated by counting additional database records as described above, and the rank may be determined according to the proportion.

### Processing Procedure by Statistical Processing Unit

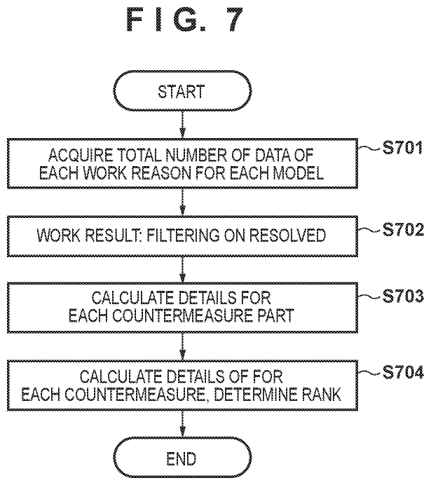

FIG. 7 is a flowchart illustrating a flow of processing performed by the statistical processing unit 411 of FIG. 4. The statistical processing method of the present embodiment is only an example, and the present invention is not limited thereto. The respective steps of the process of FIG. 7 are executed by the CPU 201 of an information processing apparatus that implements the service work record management system 102.

First, in step S701, the CPU 201 determines the number of occurrences of each of the work reasons in the work reason column 502 for each of the values of the model column 501 stored in the service work record database 408, that is, for each of the models.

Next, in step S702, the CPU 201 performs filtering to narrow results down to items for which the value of the work result column 505 is “resolved”.

Next, in step $703, the CPU 201 acquires the number of occurrences of each countermeasure part in the countermeasure part column 503 for each countermeasure reason. Then, the number of occurrences of each work reason acquired in step S701 is used as the parameter, and the proportions of countermeasure parts for the respective work reasons are calculated from the number of occurrences of the countermeasure parts acquired previously. That is, the proportions of the countermeasure parts for each model for each work reason are acquired. The results are stored in the countermeasure probability column 604 of the service work record database 600.

In step S704, the number of occurrences of each of the countermeasure content types “replacement”, “cleaning”, and “adjustment” in the countermeasure column 504 is further acquired for each countermeasure part. Then, the number of occurrences of each countermeasure part acquired in step S703 is used as the parameter, and proportions of the countermeasure content are calculated from each number of occurrences of the countermeasure content acquired previously. In other words, the proportions of the countermeasure content “replacement”, “cleaning”, and “adjustment” for each model and work reason and countermeasure part is acquired. The results are stored in the replacement column 605, the cleaning column 606, and the adjustment column 607 of the countermeasure content in the service work record database 600, respectively.

Since the processing of step S701 to step S703 references database records in the respective steps, these configurations may be collectively performed. For example, the number of database records in which the work result is “resolved” may be acquired for each model, for each work reason, for each countermeasure part by using a search function of the database, or the like. Then, a proportion for each countermeasure part may be calculated by using the number of database records for each model for each work reason as the parameter. That is, the proportion of the countermeasure parts for each model for each work reason is acquired. Then, a proportion for each countermeasure column value is calculated by using the number of database records for each model for each work reason for each countermeasure part as the parameter. This results in a proportion of a countermeasure method for each model for each work reason for each countermeasure part.

### Processing Sequence for Updating Service Manual

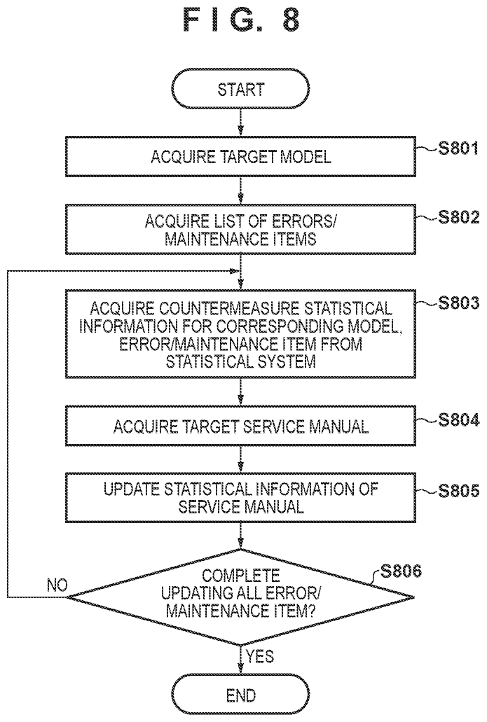

FIG. 8 is a flowchart illustrating a flow of a service manual update process performed by the market record generation unit 402 of the service manual management system 101 of FIG. 4. The respective steps of the process of FIG. 8 are executed by the CPU 201 of the information processing apparatus that implements the service manual management system 101.

First, in step S801, the CPU 201 acquires model information, for example, a model name, of a service manual update target designated by the service manual uploader 403.

Next, in step S802, the CPU 201 acquires, from the service manual content intermediate DB 404, a list of errors and maintenance items that may occur for the model to be updated.

In step S803, the CPU 201 communicates with the statistical system 407 of the service work record management system 102 to acquire statistical information for the model information of a target model and an error or maintenance item that may occur, which are acquired in step S801 and step S802. Specifically, database records in which the model information acquired in step S801 matches the value of the model column 601 in FIG. 6, and the error or maintenance item acquired in step S802 matches the value of the work reason column 602 in FIG. 6 are identified. Then, the values of the countermeasure part 603, the countermeasure probability 604, and each of the countermeasure content 605, 606, and 607 of the identified database records are acquired. For this purpose, the service work record database 600 is searched, for example, using the value of the model information acquired in step S801 and the value of the error or maintenance item acquired in step S802. Then, the values of the countermeasure part 603, the countermeasure probability 604, and each of the countermeasure content 605, 606, and 607 of the corresponding database records found as hits in that search are acquired.

Next, in step S804, the CPU 201 acquires intermediate data of the service manual corresponding to the error or maintenance item of the target model based on the model information and the list of errors and maintenance items acquired in step S801 and step S802. This intermediate data may be acquired from the service manual content intermediate DB 404 of the service manual management system 101 of FIG. 4.

Then, in step S805, the CPU 201 embeds the statistical information acquired in step S803 in a predetermined section of the intermediate data of the service manual acquired in step S804. If the statistical information has already been embedded, the existing statistical information may be overwritten with new statistical information. At this time, in order to make it easier for the maintenance worker to confirm the record order, the parts are rearranged in descending order of the countermeasure probability 604. A predetermined section for embedding the statistical information is associated with the error or maintenance item of the target model, and statistical information is associated with the error or maintenance item of the target model included in the service manual in step S805.

Finally, in step S806, the CPU 201 determines whether or not the statistical information of step S803 to step S805 has been embedded for all of the error/maintenance items in the list acquired in step S802. If it is determined that the process has not been completed, the process returns to step S803 and the embedding processing is repeatedly performed. Upon completion, the update of the intermediate data of the service manual is completed, and the intermediate data is passed to the service manual uploader 403 and the processing is finished. The service manual uploader 403 updates the service manual DB 405 with the passed intermediate data. Note that the content of the service manual DB 405 may be, for example, for each work reason (for example, an error code), an association between a countermeasure part (also referred to as a related part) and a countermeasure method, and also an association between the countermeasure probability and the countermeasure content illustrated in FIG. 6. Here, when there are a plurality of countermeasure methods, they are registered so as to be distinguishable. In addition, in association with the respective countermeasure methods, for example, an adoption ratio for each countermeasure content such as replacement, cleaning, and adjustment or a rank corresponding to the adoption ratio is registered. As a result, it is possible to associate the countermeasure methods with respective adoption ratios or ranks corresponding to the adoption ratios.

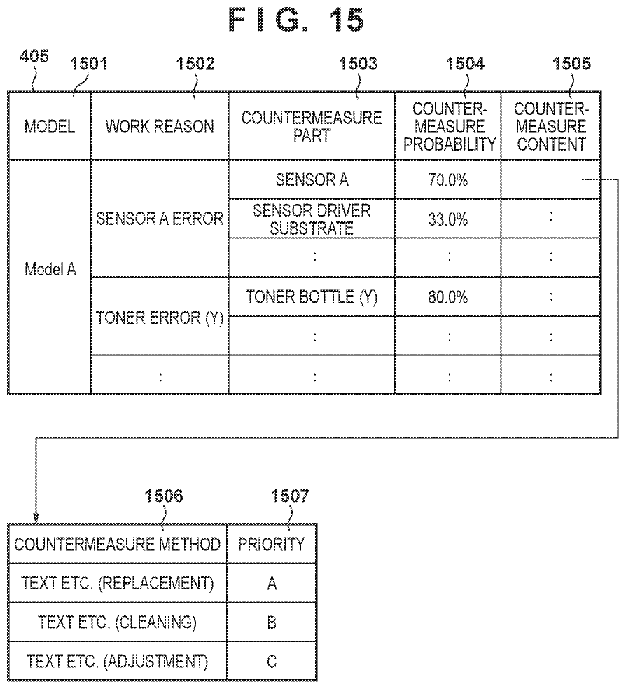

FIG. 15 illustrates an exemplary configuration of the service manual DB 405. Of course, this is only one example, and another configuration may be taken as long as models and work reasons are associated with the other items illustrated.

In the service manual DB 405, a model 1501, a work reason 1502, a countermeasure part 1503, and a countermeasure probability 1504 may be similar to those of the work record statistical information 410 in FIG. 6. All registered countermeasure methods are associated with countermeasure content 1505. In the example of FIG. 15, there are replacement, cleaning, and adjustment as countermeasure methods, and procedure information such as text, an image, or a moving image indicating each specific procedure is associated with the countermeasure content 1505 as a countermeasure method 1506. In addition, priority information indicated as the countermeasure content in FIG. 6 is registered in association with each of the countermeasure methods, and the priorities of the countermeasure methods are thereby indicated. The priority is a degree to which the measure is recommended, and a higher priority indicates a stronger recommendation.

By the above procedure, the service manual DB 405 is updated, and statistical information of error/maintenance items of a target model is updated to the latest values. As for errors, it is conceivable there are errors that are likely to occur and errors that are not, and therefore, information such as a flag indicating that the work record statistical information 410 has been updated after the service manual DB 405 is updated may be provided in the work record statistical information 410. In this case, configuration may be such that only errors or maintenance items for which such a flag indicates that work result statistical information 410 has been updated are acquired in step S803, and then the update is performed. As a result, an error or a maintenance item for which the statistical information has not been updated is not targeted for an update, and it is possible to perform update processing more quickly. Further, in this case, when the work record statistical information 410 is updated, the flag described above for the updated error or maintenance item is set to a value indicating that the work record statistical information 410 has been updated. Further, when the statistical information is acquired in step S803, the above-described flag may be set to a value indicating that the work result statistical information 410 has not been updated for the corresponding error or maintenance item.

If the above procedure is executed for all models for which a service manual is registered in the service manual DB 405, the statistical information of the service manuals of all models can be updated to the latest values.

A user, such as a maintenance worker, connects the maintenance service terminal 107 to the service manual management system 101 prior to the servicing of an image forming apparatus located at a customer's site. Then, a subset (also referred to as a worklist) of a service manual of a designated target model is downloaded from the service manual DB 405 and stored in the service manual storage area 307. Of course, the entire service manual DB 405 may be downloaded. Alternatively, if an error of the target device is identified, a portion of the database may be downloaded for the specified error or maintenance item. At the customer's site, a user connects the maintenance service terminal 107 to the information processing apparatus 104 to activate the service tool 303, and acquires, for example, information that constitutes a work reason, for example, an error code. Then, the worklist identification unit 305 identifies errors and maintenance items for which a countermeasure is to be taken based on the information acquired by the device information acquisition unit 304, for example error codes. The worklist display unit 306 displays information related to the errors and maintenance items. Further, the worklist display unit 306 acquires a worklist from a downloaded service manual DB for a maintenance item selected therefrom, and displays countermeasure methods and the statistical information thereof.

### Screen Example

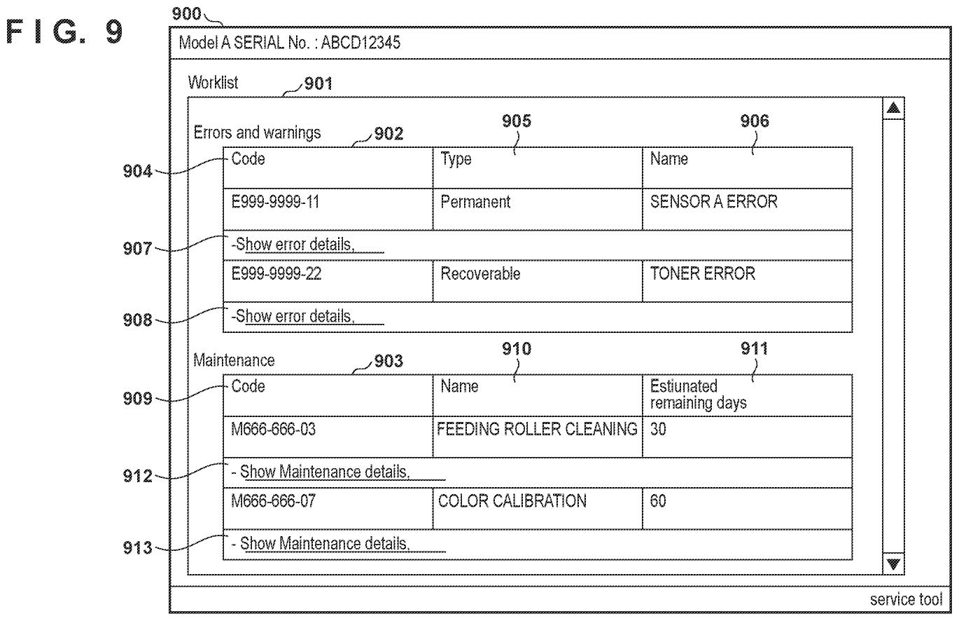

FIG. 9 is a screen example of the worklist display unit 306 of the service tool 303 of FIG. 3. The maintenance worker connects the printing company system 103 and the maintenance service terminal 107 at a location where the maintenance is to be performed, and activates the service tool 303. The service tool 303 includes the worklist display unit 306, and can display information on errors and maintenance items to be dealt with by the maintenance worker, which are identified by the worklist identification unit 305 based on the information acquired by the device information acquisition unit 304.

The screen 900 is a screen displayed on the worklist display unit 306, and includes a worklist 901 for maintenance work to be performed by a maintenance worker. Further, the worklist 901 is constituted by a worklist 902 for errors and a worklist 903 for maintenance items. The screen configuration of the present embodiment is only an example, and the present invention is not limited thereto. For example, a configuration in which the worklist 902 for errors and the worklist 903 for maintenance items are integrated and displayed as one worklist, or a configuration in which information related to maintenance work other than the worklist 901 is added to reference numeral 900 can be considered. The worklist 902 is, for example, a list of types and names corresponding to the error codes acquired by the device information acquisition unit 304, and can further include a list of errors related to the acquired error codes.

The worklist 902 for errors includes an error code column 904, a type column 905, and a name column 906.

In the code column 904, a unique code assigned to each error is displayed, and in the name column 906, the name of the error is displayed. In the type column 905, type information indicating a level of the error is displayed, and a seriousness of the error and a level of the required maintenance worker can be known by referring to the type information. The worklist 902 is displayed in an order according to the type information of the error, and more serious errors are displayed at the top. The worklist 902 can be information included in the service manual DB 405 and can be downloaded to the maintenance service terminal 107, or can be based on information held by the worklist identification unit 305. Alternatively, the information can be received from the information processing apparatus 104. When the worklist 902 is included in the service manual DB 405, a database in which a type, a name, and detailed information associated with error code are registered can be downloaded to the maintenance service terminal 107 and referred to. Here, the detailed information can be countermeasure methods for each error or maintenance item registered in the service manual DB 405, and corresponding statistical information.

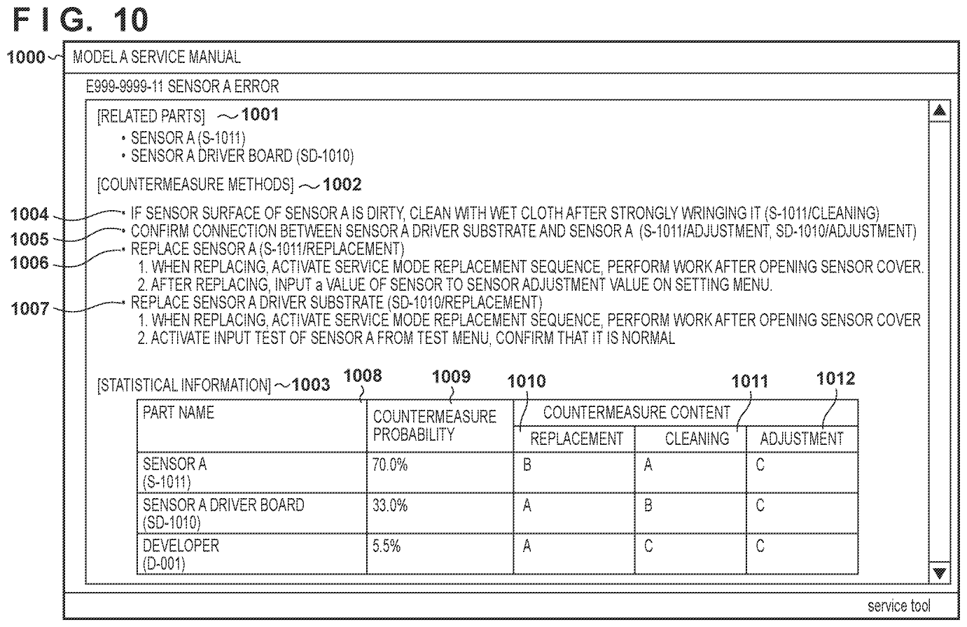

In links 907 and 908, a link for opening detailed information, that is a service manual, corresponding to the selected error is embedded. When the maintenance worker selects the link, a service manual screen of FIG. 10, which will be described later, is opened and can be referred to.

The worklist 903 for maintenance items includes a code column 909, a name column 910, and an estimated number of days remaining column 911.

In the code column 909, a unique code assigned to each maintenance item is displayed, and in the name column 910, the name of the maintenance item is displayed.

In the estimated number of days remaining column 911, the number of days remaining up to a deadline for the maintenance work is displayed. The worklist 903 is displayed in an order according to the estimated number of days remaining, and maintenance items for which the deadline is closer are displayed at the top.

In links 912 and 913, a link for opening the service manual corresponding to the selected maintenance item is embedded, and when the maintenance worker selects the link, the service manual screen of FIG. 10 described later is opened and can be referred to. It should be noted that the worklist 903 corresponding to maintenance items can be displayed for a designated maintenance item regardless of the error. Alternatively, a worklist of maintenance items related to information acquired by the device information acquisition unit 304 can be displayed. This association can be, for example, having a common countermeasure part or the like. Also, the worklist 903 can be information included in the service manual DB 405 and downloaded to the maintenance service terminal 107, or can be based on information held by the worklist identification unit 305.

### Displaying Service Manuals

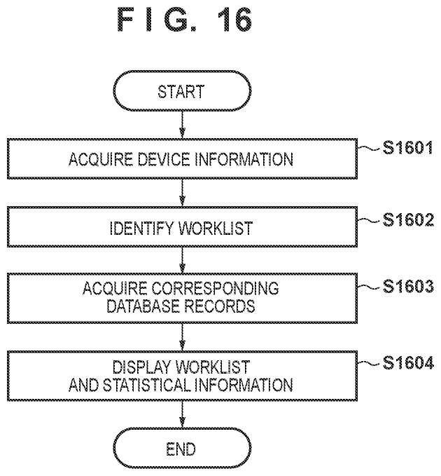

FIG. 16 illustrates a procedure for displaying a service manual in the maintenance service terminal 107. This process is executed by the CPU 201 of the maintenance service terminal 107.

First, the service tool 303 is executed by the maintenance service terminal 107 after it has connected to the information processing apparatus 104. In response to that, or in response to an instruction from a worker, the CPU 201 acquires, from the information processing apparatus 104, information of errors that have occurred in the image forming apparatus 106, for example, device information such as error codes, from the device information acquisition unit 304 (step S1601). Next, in the CPU 201, the worklist identification unit 305 identifies a worklist corresponding to the device information (step S1602). If an error code is a single item that is an index in the service manual database, a combination of model information and the error code can be used as information for identifying the worklist. The CPU 201 acquires database records of the identified worklist from the service manual database stored in the service manual storage area 307 (step S1603). Finally, the CPU 201 displays the values of each of the fields included in the acquired database records in a predetermined format on the display unit of the maintenance service terminal 107 (step S1604).

FIG. 10 is an example of a service manual displayed when the service manual stored in the service manual storage area 307 of the maintenance service terminal 107 is opened from the link 907 of the worklist 902.

A service manual 1000 is constituted by related parts 1001, countermeasure methods 1002, and statistical information 1003. The related parts 1001 and the countermeasure methods 1002 are generated by the service manual content generation unit 401, and the statistical information 1003 is generated by the market record information generation unit 402.

The related parts 1001 lists the parts associated with the error or maintenance item. In other words, the related parts 1001 can be regarded as parts that can be the cause of the error. The related parts 1001 are acquired from information of the countermeasure part 1503 of the service manual DB 405.

In the countermeasure methods 1002, procedures for taking a countermeasure against the error or maintenance item are described, and in a case where there are a plurality of causes of the error or maintenance work operations to be performed, a plurality of countermeasure methods are described, as with reference numerals 1004, 1005, 1006, and 1007. In the present embodiment, the procedures are described only by text, but the procedures can be illustrated by including an image or a moving image in the countermeasure methods. The countermeasure methods 1002 are acquired from information of the countermeasure method 1506 of the service manual DB 405.

The statistical information 1003 is constituted by a part column 1008, a countermeasure probability 1009, a countermeasure content replacement column 1010, a countermeasure content cleaning column 1011, and a countermeasure content adjustment column 1012. The statistical results acquired in step S803 of FIG. 8 by the market record information generation unit 402 specifying the model and the error/maintenance item to the statistical system 407 are displayed. In the example of FIG. 10, the corresponding statistical information is acquired from the service manual DB or a part thereof which is stored in the service manual storage area 307 by designating “sensor A error” of “Model A”.

As a result, in the part column 1008, information corresponding to the countermeasure part 1503 of the service manual DB 405 is displayed. Similarly, the countermeasure probability 1504 is displayed in the countermeasure probability column 1009, and “replacement” is displayed in the countermeasure content replacement column 1010 as a summary of the corresponding countermeasure method 1506. In the cleaning column 1011 of the countermeasure content, “cleaning” is displayed as a summary of the corresponding countermeasure method 1506. In the adjustment column 1012 of the countermeasure content, “adjustment” is displayed as a summary of the corresponding countermeasure method 1506. In addition, the corresponding rank is displayed for each countermeasure method. Further, as described above, since the information is embedded in the service manual after having changed the order of the parts to descending order of the countermeasure probability in step S805, the order of parts displayed in the statistical information 1003 is displayed in descending order of values of the countermeasure probability 1009.

A maintenance worker can refer to the statistical information 1003 to confirm countermeasure content having a greater record level (i.e., countermeasure probability and rank) in countermeasure content columns 1010, 1011, and 1012 with respect to the part having the highest countermeasure probability column 1009. As a result, even a maintenance worker who has little experience can determine a highly effective countermeasure. Then, a specific procedure of a highly effective countermeasure is searched for based on the countermeasure methods 1002, and maintenance work is performed according to the procedure. The record level such as the countermeasure probability or the rank can also be referred to as information indicating the priority of the countermeasure part or the countermeasure method to the worker referring to the countermeasure probability or the rank.

As described above, according to the present embodiment, since a service manual can be downloaded to the maintenance service terminal of the worker to be referenced, the service manual can be used without depending on the communication environment at the location of the maintenance target apparatus. Thus, a high-quality service can be provided regardless of the experience and skill of the worker.

Further, countermeasure probabilities accumulated previously for each target part are displayed, and the priority for each countermeasure method is further displayed in accordance with the proportion at which the countermeasure method was adopted. Thus, a high-quality service can be provided regardless of the experience and skill of the worker. Further, by displaying the countermeasure part and the countermeasure method in an order corresponding to the countermeasure probability of the countermeasure part, it is possible to perform the work more efficiently.

### Second Embodiment

In the first embodiment, the statistical information 1003 of the service manual 1000 is an embodiment in which the statistical results acquired from the statistical system 407 by the market record information generation unit 402 are rearranged, but the statistical results are displayed as they are. In this case, there is no problem when the accuracy of the maintenance work registered in the service work record DB 408 and the results thereof is high; however, when the work records are manually inputted by a maintenance worker, a certain number of erroneous inputs will occur. When the service work record DB 408 includes an inaccurate work record, the statistical information 1003 will be updated based on that work record. Therefore, when the maintenance worker selects a countermeasure method, there is a risk that the countermeasure method can be selected based on erroneous statistical information, and the efficiency of the work can be impaired.

Therefore, in the second embodiment, an embodiment will be described in which, a decrease in the work efficiency of the maintenance worker is prevented by an inaccurate work record that exists in the service work record DB 408 not being reflected in the statistical information 1003.

### Processing for Updating the Service Manual

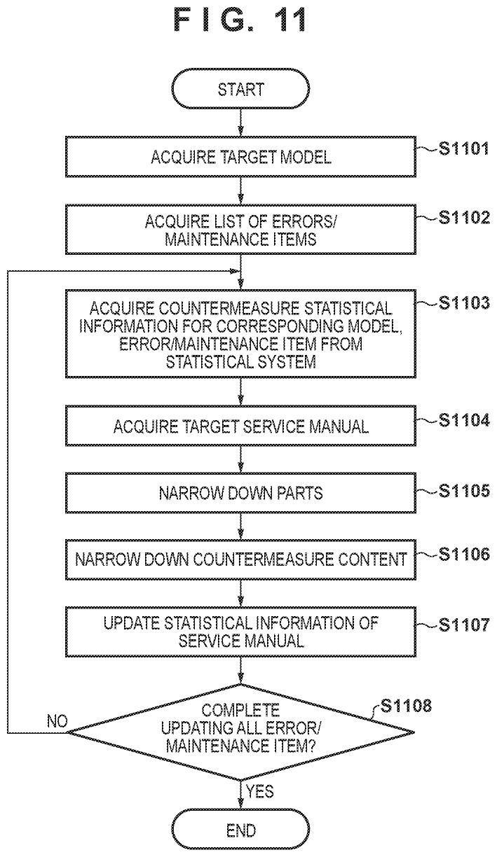

FIG. 11 is a flowchart illustrating a flow of a service manual update process performed by the market record generation unit 402 of the service manual management system 101 of FIG. 4. The basic flow is the same as that of the flowchart of FIG. 8, which is the first embodiment. Step S1101 corresponds to step S801, step S1102 corresponds to step S802, step S1103 corresponds to step S803, step S1104 corresponds to step S804, step S1107 corresponds to step S805, and step S1108 corresponds to step S806, respectively, and the processing content is the same, and therefore, explanation thereof is omitted.

In step S1105, statistical information of unrelated parts is deleted from the statistical information acquired in step S1103. At this time, the data that is the source of the related parts 1001 is extracted from the intermediate data of the service manual acquired in step S1104, and parts related to the target error or maintenance item are acquired. Configuration is such that, even if an unrelated part is included in the statistical results as a record, the information on such a part is deleted and only statistical results on related part are acquired. An “unrelated part” is, for example, a part not included among countermeasure parts extracted from intermediate data using the error code as an index.

Next, in step S1106, mask processing is applied to statistical information which has become only for related parts due to step S1105 with respect to the information of countermeasure content that is not described in the countermeasure methods 1002 of the service manual. At this time, data that is the source of the countermeasure methods 1002 is extracted from the intermediate data of the service manual acquired in step S1104, and countermeasure parts and categories of target content described as the countermeasure methods are acquired. Information is deleted by applying the mask to countermeasure content that is not described in the countermeasure methods even if it is included in the statistical result as a record.

In step S1107, as in step S805, reordering of parts according to the countermeasure probability 604 and the process of embedding into service manual intermediate data is performed, but for the results used as the source, the statistical results resulting from the processing of step S1105 and step S1106 are used.

As described above, it is possible to prevent the information related to parts that are unrelated to an error from being reflected in the service manual DB 405. In addition, a priority is not registered or displayed for countermeasure methods not described in the service manual.

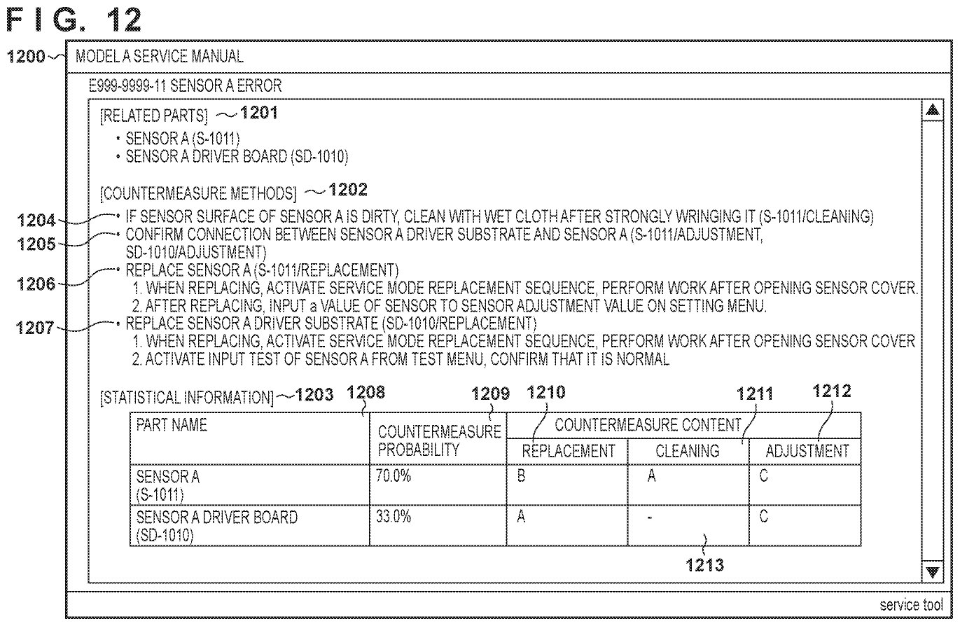

FIG. 12 is an example of a service manual generated according to the second embodiment.

The basic configuration is the same as that of the first embodiment illustrated in FIG. 10. A service manual 1200 corresponds to reference numeral 1000, a related parts 1201 corresponds to reference numeral 1001, a countermeasure methods 1202 corresponds to reference numeral 1002, and statistical information 1203 corresponds to reference numeral 1003, respectively. Also in the configuration of the countermeasure methods 1202, the countermeasure methods 1204, 1205, 1206, and 1207 correspond to reference numerals 1004, 1005, 1006, and 1007, respectively. Also in the configuration of the statistical information 1203, a part name column 1208 corresponds to reference numeral 1008, a countermeasure probability column 1209 corresponds to reference numeral 1009, and the countermeasure content 1210, 1211, and 1212 correspond to reference numerals 1010, 1011, and 1012, respectively. These components are common in FIG. 10 and FIG. 12, and thus description thereof is omitted. As can be seen from FIG. 10, the statistical information 1003 in FIG. 10 includes a developer as a target part. However, since the developer is not included in the target parts for the error of sensor A, this can be an erroneous registration in the service manual DB 405. Therefore, by performing the procedure of FIG. 11, it is possible to hide the statistical information of the developer as illustrated in FIG. 12. Also, a priority for cleaning the sensor driver A not described in the service manual is not displayed.

Due to the deletion of unrelated parts in step S1105, there is no “developer” part in the statistical information 1203 in the service manual 1200. This is because the developer is not associated with the related parts 1201 for the sensor A error, and thus is not displayed in the statistical information 1203 even if there is a record of a countermeasure for the developer in the service work record DB 408. Rank information 1213 for cleaning the sensor A driver board is also masked. This is due to step S1106. In the countermeasure methods 1202 is a description for sensor A corresponding to replacement 1206, cleaning 1204, and adjustment 1205. There is a description about the sensor A driver board corresponding to replacement 1207 and adjustment 1205. However, there is no description of a countermeasure method for cleaning of the sensor A driver board. For this reason, the cleaning rank is not displayed for the sensor A driver board as a countermeasure method. Even if there is a record that cleaning of the sensor A driver board was performed in the service work record DB, the rank information 1213 is displayed in a masked manner.

As a result, when the maintenance worker refers to the statistical information 1203, the maintenance worker can select a countermeasure method without being confused by unrelated parts or countermeasures that are not described in the countermeasure methods.

### Third Embodiment

In the first and second embodiments, the statistical results generated by the market record information generation unit 402 are displayed in the statistical information 1003 and 1203 of the service manuals 1000 and 1200. By referring to the statistical information 1003 and 1203, the maintenance worker selects a countermeasure method, searches the countermeasure methods 1002 and 1202 for the procedure of the countermeasure method, and starts the work. However, the more the countermeasure methods described in countermeasure methods 1002 and 1202 there are, the more effort the maintenance worker must make in searching through them. Therefore, in the third embodiment, an embodiment in which the effort made by the maintenance worker in searching the countermeasure methods 1002 and 1202 for a desired countermeasure method is reduced will be described. Processing for updating the service manual

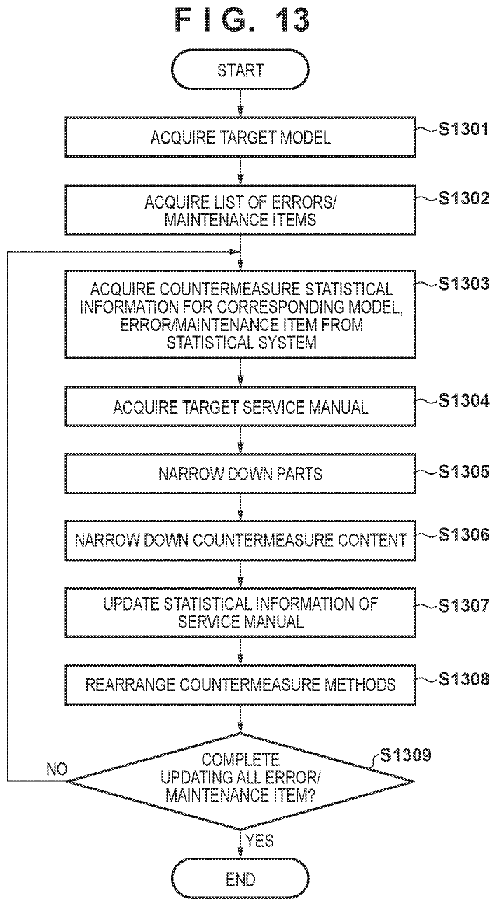

FIG. 13 is a flowchart illustrating a flow of a service manual update process performed by the market record generation unit 402 of the service manual management system 101 of FIG. 4. The basic flow is the same as that of the flowchart of FIG. 11, which is the second embodiment. Step S1301 corresponds to step S1101, step S1302 corresponds to step S1102, step S1303 corresponds to step S1103, step S1304 corresponds to step S1104, step S1305 corresponds to step S1105, step S1306 corresponds to step S1106, step S1307 corresponds to step S1107, and step S1309 corresponds to step S1108, respectively. Since the corresponding processing content is the same, description thereof will be omitted.

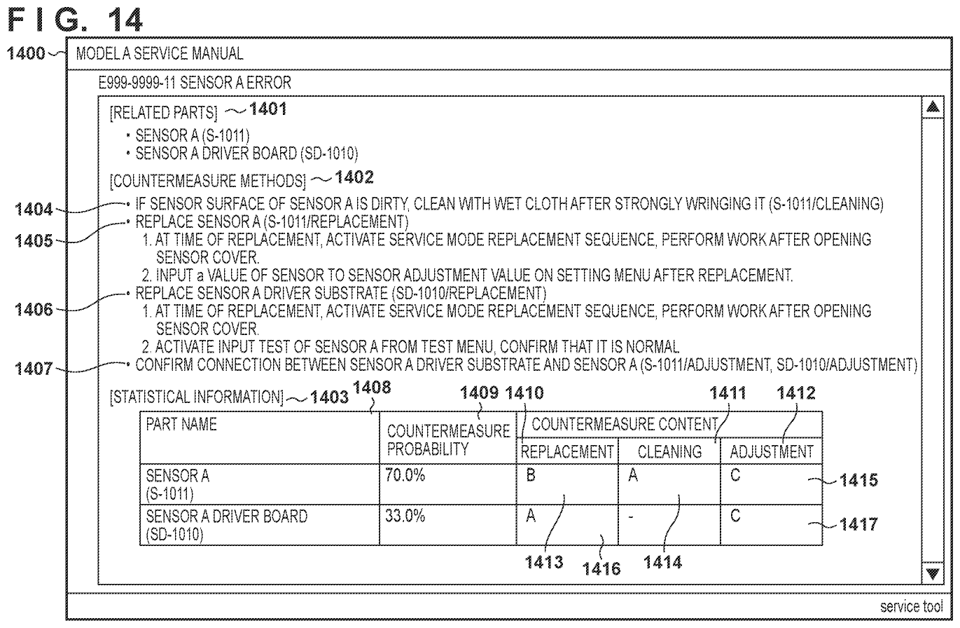

In step S1308, from the statistical results acquired in step S1303, the order of description of the countermeasure methods of the service manual (reference numeral 1402 in FIG. 14 to be described later) is changed by using the countermeasure probability 604 of the respective parts and the information of the ranks 605, 606 and 607 of the respective countermeasure content. Specifically, the rank of each countermeasure content is multiplied by the value of the countermeasure probability 604 of each part, and an estimated record value for each countermeasure for each part is calculated. In the present embodiment, the A rank is converted to 0.6, the B rank is converted to 0.3, and the C rank is converted to a coefficient of 0.1, and the estimated record value is calculated by multiplying these with the countermeasure probability 604. However, the present invention is not limited to this, and, for example, a configuration is conceivable in which a record value for each countermeasure for each part is acquired from the statistical system 407 without being calculated in this step.

The order of description in the countermeasure methods of the service manual (1402 in FIG. 14 to be described later) is rearranged to a descending order of the calculated estimated record values.

FIG. 14 is an example of a service manual generated according to the third embodiment. The basic configuration is the same as that of the second embodiment illustrated in FIG. 12. A service manual 1400 corresponds to reference numeral 1200, a related parts 1401 corresponds to reference numeral 1201, countermeasure methods 1402 corresponds to reference numeral 1202, and statistical information 1403 corresponds to reference numeral 1203, respectively. Also in the configuration of the statistical information 1403, a part name column 1408 corresponds to reference numeral 1208, a countermeasure probability column 1409 corresponds to reference numeral 1209, and the countermeasure content 1410, 1411, and 1412 correspond to reference numeral 1210, 1211, and 1212, respectively. These components are common to FIG. 12 and FIG. 14, and thus description thereof is omitted.

When the countermeasure methods described in the countermeasure methods 1402 are correlated with FIG. 12, reference numerals 1404 and 1204, 1405 and 1206, 1406 and 1207 and 1407 and 1205 refer to the same countermeasure methods, respectively. However, since the description order of the countermeasure methods 1402 is rearranged according to the estimated record value calculated in step S1308, the description order of the respective countermeasure methods is different for the countermeasure methods 1402 and the countermeasure methods 1204, and the countermeasure methods 1402 are in the descending of order of countermeasure methods having a greater record. As illustrated in the example of FIG. 14, when each countermeasure method of the countermeasure methods 1402 and the statistical information 1403 are associated, combinations of reference numerals 1413 and 1405; 1414 and 1404; 1415 and 1417 and 1407; and 1416 and 1406 are acquired. In contrast to this, when the statistical information 1403 is arranged in descending order of the estimated record values calculated in step S1307, the order becomes reference numerals 1414, 1413, 1416, 1415, then 1417. A result of rearranging the respective countermeasure methods of the corresponding countermeasure methods 1402 is the order illustrated in FIG. 14.

Thus, after the maintenance worker refers to the statistical information 1403 and determines the countermeasure method, when searching for a desired countermeasure method among the countermeasure methods 1402, the maintenance worker is enabled to more easily find the method due to the descending order of record.

The rearrangement in step S1308 can be replaced by rearranging the display order in step S1604 of FIG. 16 when the service manual is displayed. In this instance, updating the service manual DB 405 can be by the same procedure as in FIG. 8 or FIG. 11. In step S1604 of FIG. 16, a process corresponding to step S1308 of FIG. 13 can be executed. In this manner, a simpler procedure than updating the database can be taken, and it is possible to improve the flexibility of the processing by changing the display order or the like, by handling it in the display only.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-176878, filed Oct. 12, 2023, which is hereby incorporated by reference herein in its entirety.

What is claimed is:

1. An information processing apparatus that displays countermeasure methods of errors or maintenance items to a user, the apparatus comprising:
at least one memory storing instructions; and
at least one processor, that when executing the stored instructions causes the information processing to:
download, from a server, service manual information including countermeasure methods for each error or maintenance item associated with respective image forming apparatuses and a priority for each countermeasure method;
store the downloaded service manual information;
to acquire, countermeasure methods corresponding to an error or maintenance item that occurred on an image forming apparatus and a priority for each countermeasure method; and
display the countermeasure methods and priorities.

2. The information processing apparatus according to claim 1, wherein the priority includes statistical information for each part of an image forming apparatus that is a target of a corresponding countermeasure method and a rank for each countermeasure method.

3. The information processing apparatus according to claim 2, wherein
the processor is further configured to, in a case where a countermeasure method is not included in the service manual information, not display the rank of the countermeasure method not included in the service manual information.

4. The information processing apparatus according to claim 1, wherein the priority of each of the countermeasure methods is based on a ratio at which the countermeasure methods are adopted.

5. The information processing apparatus according to claim 1, wherein the processor is further configured to, for a countermeasure method for a part of an image forming apparatus that is not a part that is a target of the countermeasure methods, does not display a priority of the countermeasure method.

6. The information processing apparatus according to claim 1, wherein the processor is further configured to display the countermeasure methods in an order corresponding to the priority of each of the countermeasure methods.

7. The information processing apparatus according to claim 6, wherein the processor is further configured to display the countermeasure methods in an order corresponding to an estimated record value resulting from multiplying a coefficient corresponding to a rank of the countermeasure method with statistical information of a part of an image forming apparatus associated with the countermeasure method.

8. The information processing apparatus according to claim 1, wherein the processor is further configured to download a designated portion in the service manual information, which is stored on the server.

9. A maintenance support system, comprising:
the information processing apparatus;
a first server; and
a second server,
wherein the information processing apparatus comprises:
at least one memory storing instructions, and
at least one processor, that when executing the stored instructions causes the information processing to:
download, from a server, service manual information including countermeasure methods for each error or maintenance item associated with respective image forming apparatuses and a priority for each countermeasure method,
store the downloaded service manual information,
acquire, countermeasure methods corresponding to an error or maintenance item that occurred on an image forming apparatus and a priority for each countermeasure method, and
display the countermeasure methods and priorities,
wherein the first server is configured to store service manual information including countermeasure methods corresponding to an error or a maintenance item associated with respective image forming apparatuses and priorities corresponding to the countermeasure methods and to provide the service manual information to the information processing apparatus, and
wherein the second server is configured to collect and update statistical information for the countermeasure methods for each error or maintenance item, and
wherein the priorities of the service manual information stored in the first server are updated based on the statistical information stored in the second server, and
wherein the information processing apparatus downloads and stores at least a portion of the service manual information from the first server.

10. A maintenance support method in a maintenance support system comprising an information processing apparatus, a first server configured to store service manual information including countermeasure methods corresponding to each of errors or maintenance items for respective image forming apparatuses and priorities corresponding to the countermeasure methods and to provide the service manual information to the information processing apparatus, and a second server configured to collect and update statistical information for the countermeasure methods for each error or maintenance item,
the maintenance support method comprising:
updating the priorities of the service manual information stored in the first server based on the statistical information stored in the second server; and
downloading and storing at least a portion of the service manual information from the first server.

11. The maintenance support method according to claim 10, further comprising acquiring, from at least a portion of the stored service manual information, countermeasure methods corresponding to an error or maintenance item that occurred on an image forming apparatus and a priority for each countermeasure method, and displaying the countermeasure methods and priorities.
